(19) United States
(12) Patent Application Publication
(10) Pub. No.: US 2004/0234179 A1
(43) Pub. Date: Nov. 25, 2004

(54) Length-expandable linear guideway

(76) Inventor: Hsin-Liang Chen, Taichung (TW)

Correspondence Address: CHARLES E. BAXLEY, ESQ., 90 JOHN STREET, THIRD FLOOR, NEW YORK, NY, 10038, US

(21) Appl. No.: 10/444,758

(22) Filed: May 23, 2003

(51) Int. Cl. F16C 29/04

(52) U.S. Cl. 384/49

(57) ABSTRACT

The present invention relates to a length-expandable linear guideway, which main includes a slide way that can change the distance. The main characteristic of it is the slideway of the linear guideway has the function of the expanded and contracted. Thereby this model can cut down the install space of the linear guideway, and can enlarge the application scope of the linear guideway.

### BACKGROUND OF THE INVENTION

1. Field of the Invention

The present invention relates to a length-expandable linear guideway, which main includes a slide way that can change the distance. The main characteristic of it is the slideway of the linear guideway has the function of the expanded and contracted. Thereby this model can cut down the install space of the linear guideway, and can enlarge the application scope of the linear guideway.

2. Description of the Prior Arts

A conventional linear guideway as shown in FIG. 6, which includes a fixed guide track 50 disposed on a datum level, also includes a object (not shown) disposed on the sliding block 40, the sliding block 40 is slidably mounted on the fixed guide track 50 so that the object to be born is permitted to linearly move along the fixed guide track 50. The maximum travel of the linear track is exactly same as the movable distance of the sliding block 40 on the fixed guide track 50, which equals, the length L of the fixed guide track 50 minus that N of the sliding block 40, thereby, the longer the moving distance is, the longer of the rail length L to be required. Vice versa, in case that the required moving distance is fixed, the longer the length N of the sliding block 40 is, the longer the rail length L to be required. However, the length of the fixed guide track 50 is normally fixed, so the longer the length of the fixed guide track 50 is, the larger installation space should be required. Nowadays, the linear guideway has been commonly applied in precision and normal machinery, so the install space of the linear guideway demands to be saved; otherwise the application scope of it will be restricted.

The present invention has arisen to mitigate and/or obviate the afore-described disadvantages of the conventional linear guideway.

### SUMMARY OF THE INVENTION

Due to the linear guideway has been applied to the general mechanical transmissions in a wide range, such as feeder of a manufactory, automatic-doors used in all kinds of surroundings (train, shop, public places and so on), however, the stall space is one of the common problems of them should be overcome.

The length-expandable linear guideway of the present invention changes the guideway structure from length-fixed structure into a length-expandable one which having a function of expanded and contracted. By utilizing the theory of tandem and telescopic, the slideway of the present invention is designed as a structure that can change the distance, viz. the slideway of the present invention can expand to a maximum extent based on the tandem structure, while the same can be contracted to a minimum extent based on the telescopic design. Thereby the linear guideway of the present invention has a function of contracted and expanded such that can cut down the stall space of it and expand the distance of the linear slideway to a moderate degree as needed.

The linear guideway of the present invention has been changed from the conventional type of consisting of a length-fixed guideway structure for fitting into the bearing rail (carriage) into a length-expandable guideway for fitting the bearing rail (carriage), which including a fixed and a slidable portion. Thus, the linear guideway structure of the present invention, in a telescopic manner without adding extra spaces, is able to expand the length of it sector by sector by virtue of a tandem manner. In other words, which can be tandem linked in different sectors as needed to extend the length. By such an arrangement, the maximum extent of the expandable linear guideway of the present invention can be achieved and expanded without extra spaces being required, thus the install space of such the expandable linear guideway of the present invention is relatively cut down and overcome the problem of install space. Furthermore, which can expand the length to a moderate extent so as to enlarge the application scope of the linear guideway as well as improve the competitive power of the same.

The primary objective of the present invention is to provide an expandable linear guideway of one-way directional or bi-directional expandable for purpose of saving space of installation.

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 is an exploded view of a length-expandable linear guideway in accordance with a first embodiment of the present invention;

FIG. 2 is a perspective view of the length-expandable linear guideway in accordance with the first embodiment of the present invention, showing an expanded status;

FIG. 3 is a perspective view corresponding to FIG. 2 of showing a contracted status of the length-expandable linear guideway of the present invention;

FIG. 4 is a perspective view of the length-expandable linear guideway in accordance with a second embodiment of the present invention, showing an expanded status;

FIG. 5 is an exploded view of the length-expandable linear guideway in accordance with the present invention;

FIG. 6 is a plan view of a conventional length-expandable linear guideway.

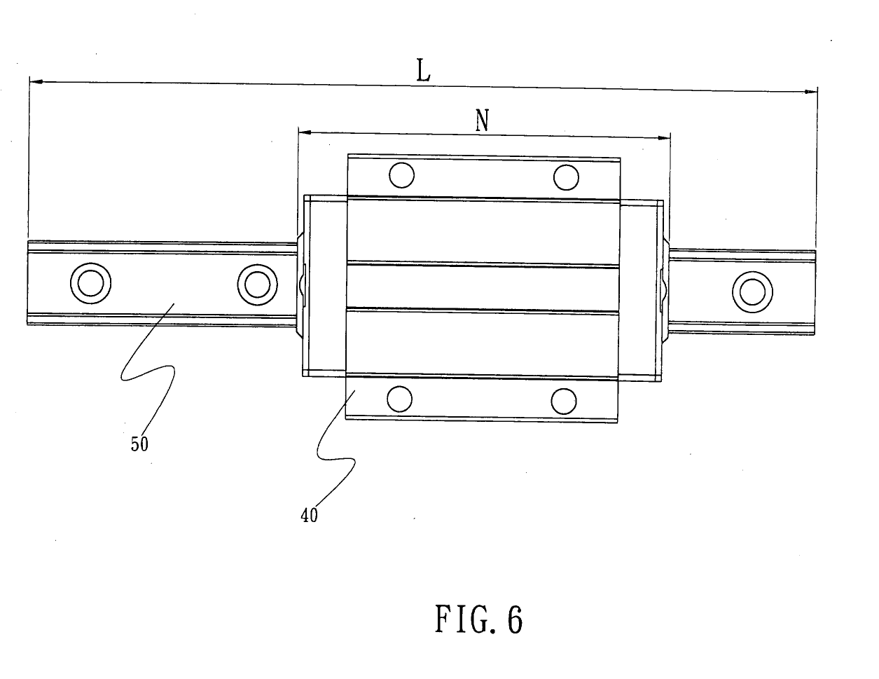

### DETAILED DESCRIPTION OF THE PREFERRED EMBODIMENTS

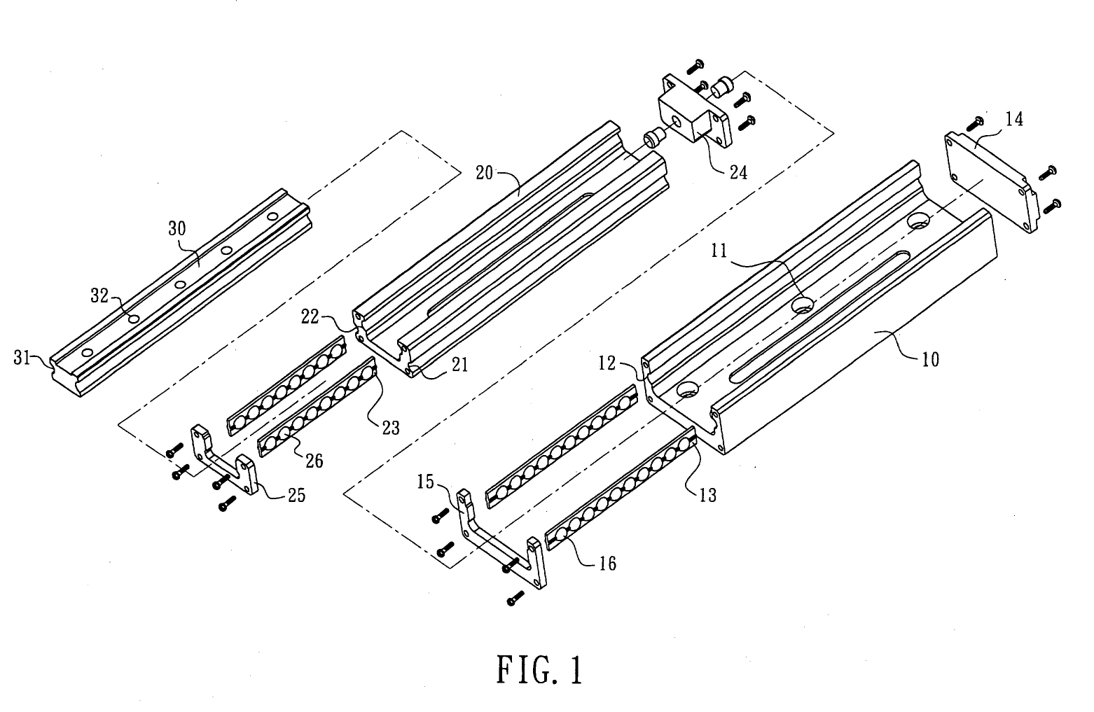

FIG. 1 is an exploded view of a length-expandable guideway in accordance with a first embodiment of the present invention, wherein a length-expandable linear guideway of the present invention consists of a base guide track 10, a U-shaped guide track 20 and a slide base 30. The base guide track 10 includes a plurality of apertures 11 formed at the bottom so as to be fixed on a datum level by virtue of the apertures, and includes two ball grooves 12 formed at both inner lateral sides respectively, the two ball grooves 12 corresponding to two ball grooves 21 are formed at both outer lateral sides of the U-shaped guide track 20 respectively. Two connecting members 13 are respectively disposed between the ball grooves 12,21 for confining the slide of the balls 16 therebetween. A cover plate 14 and stop plate 15 are disposed at both ends of the base guide track 10 respectively for preventing the connecting members 13 sliding out therefrom, such that the slide of the connecting members 13 are confined within the base guide track 10. Similarly, two ball grooves 22 are formed at both inner lateral sides of the U-shaped guide track 20 respectively, the two ball grooves 22 are corresponding to two ball grooves 31 formed at both outer lateral sides of the slide base 30. Two connecting members 23 are disposed between the ball grooves 22 and 31 for confining the balls 26 and sliding therebetween. A cover plate 24 and a stop plate 25 are disposed at both ends of the U-shaped guide track 20 respectively for preventing the connecting members 23 sliding out therefrom, such that the slide of the connecting members 23 is confined within the U-shaped guide track 20. Therefore, the U-shaped guide track 20 is movable relative to the base guide track 10 and the slide base 30 respectively, and the object is fixed in the fixed holes 32 of the slide base 30 and permitted to move along the U-shaped guide track 20.

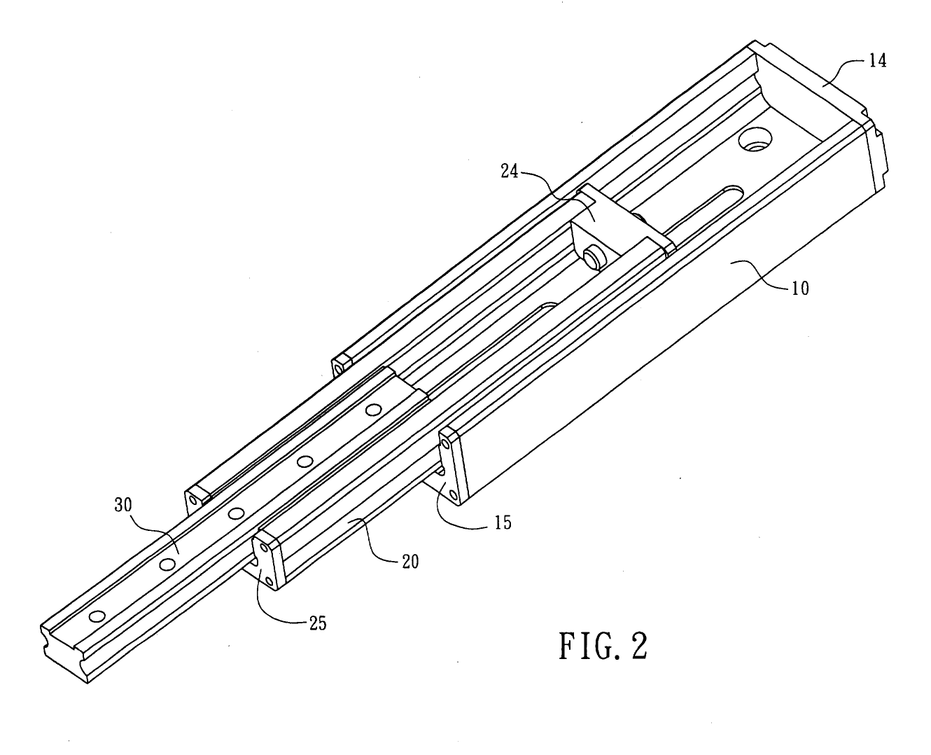

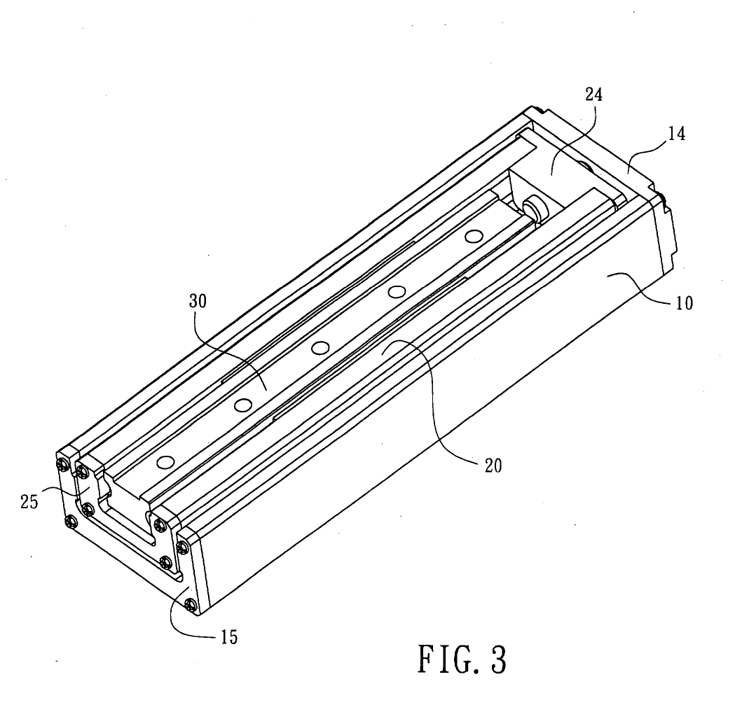

Referring to FIGS. 2-3, FIG. 2 is a perspective view of the length-expandable linear guideway in accordance with the first embodiment of the present invention, showing an expanded status. FIG. 3 is a perspective view corresponding to FIG. 2 of showing a contracted status of the length-expandable linear guideway of the present invention. The U-shaped guide track 20 is movable within the base guide track 10 and the slide base 30 is also movable within the U-shaped guide track 20, thereby the guiding travel of the length-expandable linear guideway in accordance with the present invention equals the moving travel of the U-shaped guide track 20 within the base guide track 10 plus that of the slide base 30 within the U-shaped guide track 20, viz. the moving travel of the expandable linear guideway of the present invention is two times longer comparing with the original one. When the U-shaped guide track 20 moves back into the base guide track 10 and so does the slide base 30 move back into the U-shaped guide track 20 simultaneously, so that the base guide track 10, U-shaped guide track 20 and slide base 30 may be superposed one another. Thereby, the length of the length-expandable linear guideway in accordance with the present invention is shortened. That is to say, the install space is saved. On the other hand, in order to allow the slide base 30 and the U-shaped guide track 20 to expand from the U-shaped guide track 20 and the base guide track 10 respectively, the stop plates 15,25 are open-slot formed respectively at an end of the base guide track 10 and the U-shaped guide track 20 so that the slide base 30 and the U-shaped guide track 20 are permitted to expand from the end of the U-shaped guide track 20 and the base guide track 10 respectively where the stop plates 25,15 are correspondingly disposed and the moving travel of the length-expandable linear guideway is lengthened.

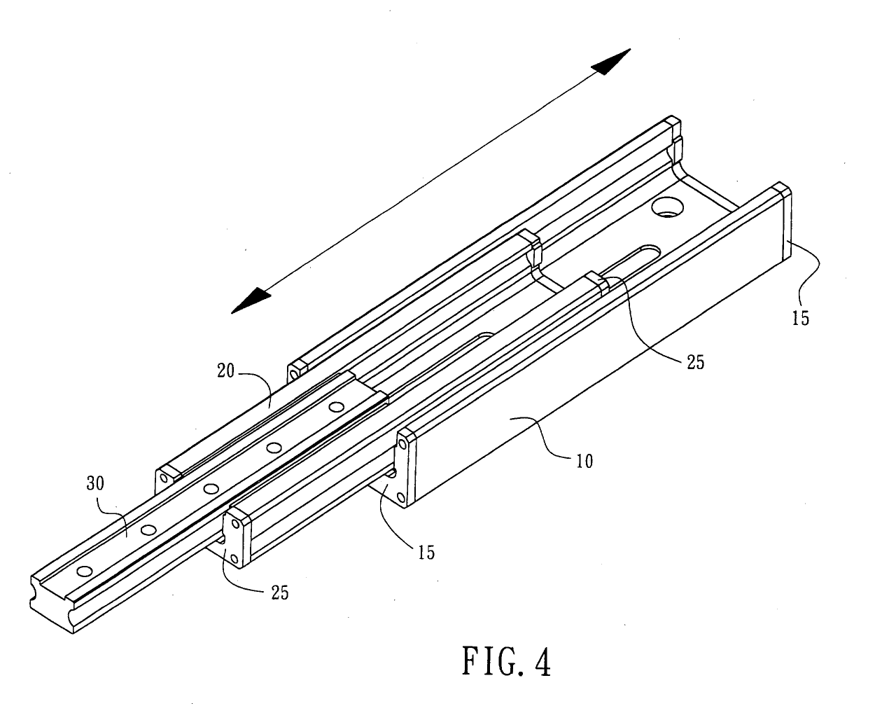

FIG. 4 is a perspective view of the length-expandable linear guideway in accordance with a second embodiment of the present invention, showing an expanded status. In which, the length-expandable linear guideway of the present invention is permitted to expand bi-directionally. Thereby both ends of the U-shaped guide track 20 and the base guide track 10 are provided with an open-slot shaped stop plates 25 and 15 so that the slide base 30 and the U-shaped guide track 20 are permitted to extend from both ends of the U-shaped guide track 20 and the base guide track 10 respectively where the stop plates 25, 15 are correspondingly disposed, such that the moving travel of the length-expandable linear guideway is lengthened.

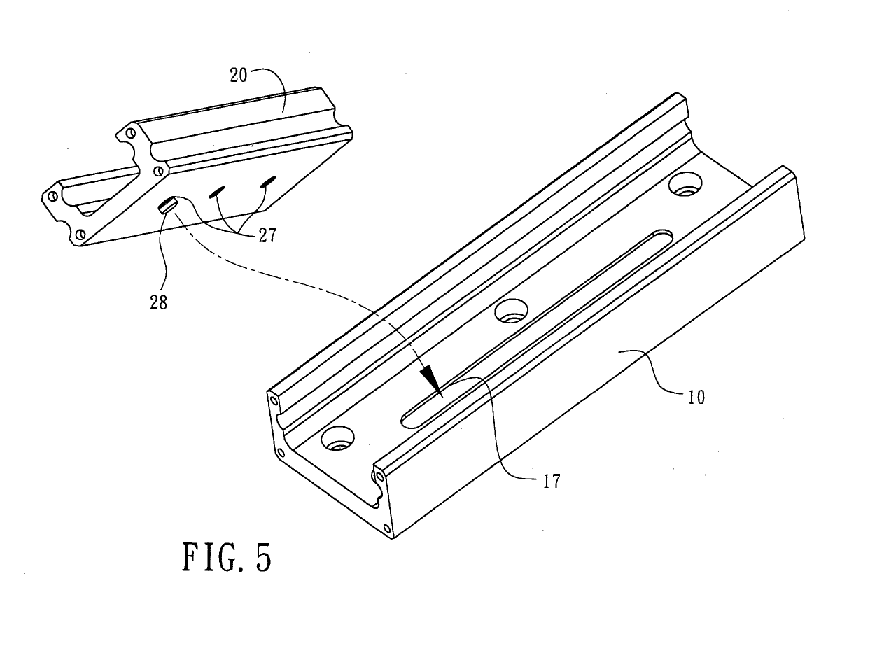

Referring further to FIG. 5, which shows another limiting device on the moving travel of the length-expandable linear guideway for purpose of preventing the slide base 30 and the U-shaped guide track 20 from sliding out therefrom. Wherein a locating slot 17 is formed at the bottom of the base guide track 10, and alike, a plurality of locating apertures 27 are formed at the bottom of the U-shaped guide track 20, a locating bolt 28 is engaged with one of the locating apertures 27 at a predetermined position then the moving travel of the U-shaped guide track 20 can be restricted by the cooperation between the locating bolt 28 and the locating apertures 27. The expanding direction of the length-expandable linear guideway can be changed by the change of the locating bolt's 28 engaging position with the locating apertures 27. In case that the locating bolt 28 on the U-shaped guide track 20 engages with the locating aperture 27 on the left, the U-shaped guide track 20 is permitted to expand out from the right end of the base guide track 10. The U-shaped guide track 20 is permitted to expand out from both ends of the base guide track 10 in case that the locating bolt 28 engages with the locating aperture 27 in the middle. The rest is deduced by this analogy. And alike, this limiting device on the moving travel is also applicable to the slide base 30 so as to restrict the moving travel of it by cooperating with the U-shaped guide track 20.

It should be clear to those skilled in the art that further embodiments may be made without departing from the scope of the present invention.

What is claimed is:

1. A length-expandable linear guideway at least comprising:
a base guide track defined on a datum level, including two ball grooves formed at both inner lateral sides thereof;
a slide base guiding an object for linearly moving, including two ball grooves formed at both outer lateral sides thereof;
a plurality of balls;
connecting members for confining the relative position of the balls; and
an U-shaped guide track including two ball grooves formed at both inner lateral sides thereof and two ball grooves formed at both outer lateral sides thereof, the two ball grooves formed at both inner lateral sides corresponding to that of the two ball grooves formed at both outer lateral sides of the slide base, the two ball grooves formed at both outer lateral sides of the U-shaped guide track corresponding to that of the two ball grooves formed at both inner lateral sides of the base guide track;
wherein a plurality of balls and the connecting members disposed between each pair of corresponding ball grooves, whereby to allow the base guide track, the slide base and the U-shaped guide track to move relative to each other, said length-expandable linear guideway accordingly being expandable and saving the installation space.

2. The length-expandable linear guideway as claimed in claim 1, wherein a stop plate is disposed at an end of the U-shaped guide track and the other stop plate is disposed at an end of the base guide track whereby to confine the slide of the balls and the connecting members within the scope of the U-shaped guide track and the base guide track.

3. The length-expandable linear guideway as claimed in claim 1, wherein a cover plate is disposed at an end of the U-shaped guide track and the other cover plate is disposed at an end of the base guide track whereby to confine the rolling movement of the balls and the connecting members within the scope of the U-shaped guide track and the base guide track.

4. The length-expandable linear guideway as claimed in claim 1, wherein the U-shaped guide track, slide base and base guide track are bi-directionally movable relative to each other.

5. The length-expandable linear guideway as claimed in claim 1, wherein the U-shaped guide track, slide base and base guide track are one-way directionally movable relative to each other.

6. The length-expandable linear guideway as claimed in claim 1, wherein each of the U-shaped guide track, slide base and base guide track is provided with a limiting device on moving travel for preventing the relatively moving elements from sliding out therefrom.

7. The length-expandable linear guideway as claimed in claim 2, wherein each of the U-shaped guide track, slide base and base guide track is provided with a limiting device on moving travel for preventing the relatively moving elements from sliding out therefrom.

8. The length-expandable linear guideway as claimed in claim 3, wherein each of the U-shaped guide track, slide base and base guide track is provided with a limiting device on moving travel for preventing the relatively moving elements from sliding out therefrom.

9. The length-expandable linear guideway as claimed in claim 4, wherein each of the U-shaped guide track, slide base and base guide track is provided with a limiting device on moving travel for preventing the relatively moving elements from sliding out therefrom.

10. The length-expandable linear guideway as claimed in claim 5, wherein each of the U-shaped guide track, slide base and base guide track is provided with a limiting device on moving travel for preventing the relatively moving elements from sliding out therefrom.

11. The length-expandable linear guideway as claimed in claim 6, wherein the limiting device includes a locating bolt and a locating slot, the moving travel of corresponding moving elements is restricted by the cooperation between the locating bolt and the locating slot, with the change of the locating bolt's engaging position relative to the locating slot, the expanding direction of the length-expandable linear guideway is changed.
